(19) United States
(12) Patent Application Publication
(10) Pub. No.: US 2023/0149936 A1
(43) Pub. Date: May 18, 2023

(54) APPARATUS FOR REMOVING THE HUSK FROM GRAIN

(71) Applicant: LEHNER Maschinenbau GmbH, Westerstetten (DE)

(72) Inventor: Ralf HUEBNER, Donzdorf (DE)

(73) Assignee: LEHNER Maschinenbau GmbH, Westerstetten (DE)

(21) Appl. No.: 17/920,498

(22) PCT Filed: Apr. 16, 2021
(86) PCT No.: PCT/EP2021/059899

§ 371 Date: Oct. 31, 2022

(30) Foreign Application Priority Data
Apr. 23, 2020 (WO) 20171114.0

(51) Int. Cl. B02B 3/02

(52) U.S. Cl. CPC B02B 3/02

(57) ABSTRACT

An apparatus for removing the husk from grain, in particular as a laboratory or small-scale grain kernel peeler, and for producing dehusked grain seeds, has a peeler including a first disk and a second disk movable relative to the first disk and drivable about a vertical axis. The disks enclose, between main faces made of a temperature-stable and elastic material, a working space fillable with grain from the side opposite the second disk through a central first disk filling opening. By rotating the second disk, the kernel and husk can be separated by a radial movement along the disks so that kernel and husk leave the peeler on its outer circumference via an outlet which opens via a chute into a collecting bin, the chute having a lateral air inlet supplied with an air stream so that the husks leave the chute laterally in front of the collecting bin.

The invention relates to a device for the dehusking of husk cereals, in particular as laboratory or small-quantity peeler of husk cereals and for the production of dehusked husk cereal seeds.

In contrast to the so-called naked grain, the cereal grains of which can be exposed by threshing, husk grains are provided with spelts which are firmly closed around the grains and which are indigestible for humans and have to be removed in special devices. Among other things, husk cereals include, but are not limited to, spelt, grain, emmer or rice, as well as oats, millet and buckwheat. In these types of cereal, it is necessary to remove the husks before processing. For this purpose, so-called peeling mills are known from the general state of the art, which are, for example, for husk cereals. In this context, in particular in the case of the cereal variety spelt, it is referred to as dehusking.

Other devices known from the state of the art include so-called underrotor peeling devices, in which a dehusking between stone wheels is carried out. However, such devices can often lead to damage to the surface of the grain, so that with such devices from the prior art the germination ability of the grain cannot be ensured.

In DE 38 038 58 A1, a spelt peeling machine is shown, in which a rotatable friction disc and a non-rotatable friction disc are arranged in a housing in such a way that the axes of the friction discs lie horizontally, so that the net weight of the discs does not affect the gap spacing between the discs. The friction discs are provided with friction grooves which run in a star shape from the inside to the outside and have a V-shaped or cone-shaped cross-section. The friction disks can be manufactured completely or partially from a rubber or plastic.

The AT 357 009 B shows a device for removing fruit skin and pulp and for partial drying of washed cereals and legumes.

U.S. Pat. No. 2,791,254 discloses a seed peeler comprising two partially elastic discs. For this purpose, the rotating and non-rotating shafts can be constructed in such a way that the side facing the fruit consists of a plastic or rubber.

DE 306225 describes a machine for the dehusking of cereals, in which the grain is guided against a solid disc which rotates rapidly in a housing and which is provided on the circumference with strips which generate air swirl which effects the opening of the entrained husks within the housing.

In DE 270156, a mill with a mounted centrifugal separator is described, in which the viewing wing is used by replacing the drum jacket surrounding it, for peeling and dehulling (dehusking, roughening), for the purpose of being able to carry out the three process steps, dehusking, peeling and flour preparation, with one and the same machine.

In particular, the two last-mentioned devices had horizontal axis of the peeling devices, so that the high mechanical loads which are produced by downwardly falling grain, which are not distributed symmetrically in the peeling device, are produced when the husking device is released.

Due to the increasing use of husk cereals as cereal species in food production, large-scale industrial plants have become established, in which a separation of husk and grain is carried out only after dehusking in a separate plant.

Against this background, the inventor has now found the object of providing an improved device for the dehusking of husk cereals, which can be used as laboratory or small-quantity peeler of husk cereals and for the production of dehusked husk cereal seeds.

This object is achieved by the independent patent claim 1. Further advantageous embodiments of the invention are in each case objects of the dependent claims. These can be combined with one another in a technologically meaningful manner. The description, in particular in connection with the drawing, further characterizes and specifies the invention.

In accordance with the invention, there is provided a device for the dehusking of husk cereals, in particular as laboratory or small-quantity peeler of husk cereals and for the production of dehusked husk cereals, which comprises a peeling device which comprises a first disk and a second disk which is movable relative to the first disk and which can be driven about a vertical axis of rotation wherein the disks enclose a working space between their main surfaces having a surface made of a plastic material, which working space can be filled by a filling hole of the first disk in the region of its centre point with husk grain, wherein by rotation of the second disk a peeling off of grain and husk of the husk grain takes place by means of a radial movement along the disks so that grain and husk of the husk grain leave the peeling device on the outer circumference via an outlet opening, which opens into a collecting vessel via a downpipe, wherein the downpipe has a lateral supply air opening, which is acted upon by an air flow such that husk leaves the downpipe laterally in front of the collecting vessel.

Accordingly, in the device according to the invention, a peeling device for removing husk is extended in such a way that the functionality of air flow separation is supplemented in order to separate the husk via an air flow. In this case, the grain and husk of the husk grain leave the peeling device via the exit opening, wherein only the grain is received in the collecting vessel, while husk leaves the downpipe laterally. Accordingly, it is not necessary, as has already been shown in the state of the art, to provide a separate device for dehusking and for separating by air flow. Furthermore, the device according to the invention has a peeling device in which the moving second disk is driven about the vertically arranged axis of rotation. In this case, the main surfaces of the disks enclose the working space in a plane perpendicular to the axis of rotation, so that the filling opening ensures a uniform distribution during filling via the two disks of the peeling device. Unlike the already known mills with a horizontal axis of rotation, there are no asymmetrical thermal loads in the peeling direction, which significantly improves the service life of the device according to the invention. Such a construction is advantageous, in particular, in the dehusking of husk cereals in small quantities or for analysis purposes in a laboratory for quality control, since in a single step, dehusking and separation of grain and husk takes place. Due to the homogeneous temperature distribution in the interior of the peeling mechanism, the disks of the peeling mechanism can be selected relatively compactly with respect to their dimensions, so that a hand-held device can be created, which is easy to operate and can be used in many ways.

According to an embodiment of the invention, the first disk and the second disk each have a carrier plate, which are preferably made of aluminium.

It has been found that for homogeneous temperature distribution in the interior of the peeling unit, advantageously the two disks each have a carrier plate, wherein in particular carrier plates made of aluminium are used, which has a high thermal conductivity, has the necessary mechanical stability and can nevertheless be manufactured cost-effectively. Other materials having high thermal conductivity, such as metals such as copper or metal alloys, may also be used.

According to a further embodiment of the invention, the material consisting of a temperature-stable and elastic material is a plastic material or a natural rubber. A food-genuine polyurethane can be applied to the main surfaces of the first disk or the second disk. However, the plastic material may also be made of silicone on the main surfaces of the first disk or of the second disk.

However, materials with a high thermal conductivity are unsuitable for dehusking husk cereals, so that the region of the two disks delimiting the working space is coated with a plastic material which can be selected for the removal of husk grain, in particular as a food-genuine polyurethane. In order to develop seed grains for the production of seed, it has been found that a silicone material is advantageous since, after leaving the device according to the invention, it has a high driving force after leaving the device according to the invention.

According to a further embodiment of the invention, the material that is stable and elastic from a temperature-stable and elastic material is connected to the carrier plate in a form-fitting or material-locking manner.

Advantageously, the plastic material is glued onto the carrier plate, so that, in a simple manner, worn temperature-stable and elastic material can be exchanged. However, it is also conceivable to spray the carrier plate or a vulcanizing process. In other applications, a blank of the temperature-stable and elastic material can also preferably be screwed onto the carrier plate by means of countersunk screws.

According to a further embodiment of the invention, the second disk is coupled to an electric motor.

The second disk, which is movable about the axis of rotation, is advantageously coupled to an electric motor, which can contain, without further deflection or transmission order, directly as a component the axis of rotation. In this way, a compact construction can be achieved in which the components of the electric motor are arranged in a space-saving manner around the vertical axis of rotation.

According to a further embodiment of the invention, the electric motor is additionally coupled to a suction fan for generating the air flow. However, a further electric motor can also be additionally coupled to a suction fan for generating the air flow.

The suction fan required for applying the air flow can also be coupled to the electric motor driving the second disk. In other embodiments, it is likewise possible to provide alternatively a wide electric motor which is used only for the suction fan.

According to a further embodiment of the invention, the axial spacing of the disks can be variably adjusted. In this case, the second disk can be provided with a spindle drive in order to adjust the distance from the first disk, in particular in a range between 0.1 mm and 10 mm. In particular in the case of husk cereals, the proportion of the husk to be removed is quite considerable in respect of the entire grain prior to the dehusking, so that, for example, when filling with approx. 5 litres of original husk cereal grain, a collecting container or collecting bag of 6 litres or more would be filled with the device according to the invention, whereas in the collecting vessel only 0.2 to 0.5 litres of dehusked husk grain. In order to be able to adjust the dehusking process precisely, it is also necessary to precisely adjust the position of the two disks relative to one another. The invention uses an axial adjustment, wherein the first disk can be moved in the axial direction relative to the first disk. For this purpose, in particular, a spindle drive can be provided which, with corresponding precision threads, permits reproducibility of the spacing of the two disks with high accuracy. Typically, the distance is changed in a range between 1 mm and 10 mm, the distance being adjustable more precisely than 0.1 mm. In the device according to the invention, the second disk is moved together with the axis of rotation and the electric motor, wherein overlapping housing sections are assigned to both the first disk and the second disk along the outer circumference of the peeling device so that, even in the event of an adjustment of the distance of the first disk to the second disk, there is no gap on the outer circumference, through which husk or husk grain could leave the device according to the invention.

According to a further embodiment of the invention, the first disk is thermally connected to a main body of the device.

Since only the second disk is moved, the first disk can advantageously be thermally connected to a main body of the device in order to be able to remove the heat produced during the dehusking via the main body.

According to a further embodiment of the invention, the main surface of the of the first disk recedes in the radial direction in the opposite direction to the second disk to the second disk in the radial direction.

The configuration of the region of the filling opening is important, in particular, for the first disk for good filling with husk grain, wherein here in particular a wedge-shaped design which widens towards the centre point has proven successful.

According to a further embodiment of the invention, one or more strippers are arranged below the second disk, which strippers support the leaving of grain and husk of the husk grain in the direction of the outlet opening.

In order to improve the leaving of grain and husk, the second disk is provided with a stripper or a plurality of strippers which, due to the rotational movement of the second disk, push the material located under the second disk in the direction of the outlet opening. As a result of the centrifugal forces, grain and husk thus arrive at the outlet opening, which therefore only has to be arranged over a small region on the outer circumference of the peeling device, so that the downpipe only has to have a small diameter.

Furthermore, a method for the dehusking of husk cereals, in particular as laboratory or small-quantity peeler of husk grains, and for the production of dehusked husk cereal seeds with a device, as described above, is specified, which delivers approximately 1 kg of corresponding grain or seed per minute.

For small amounts of up to, for example, 200 kg, the device according to the invention can advantageously be used in a method for dehusking husk grain, so that, in addition to an application in a laboratory, the production in a small mill is also conceivable. Likewise, the device according to the invention can also be used in a seed producer.

Exemplary embodiments are explained in more detail below with reference to the drawing, in which:

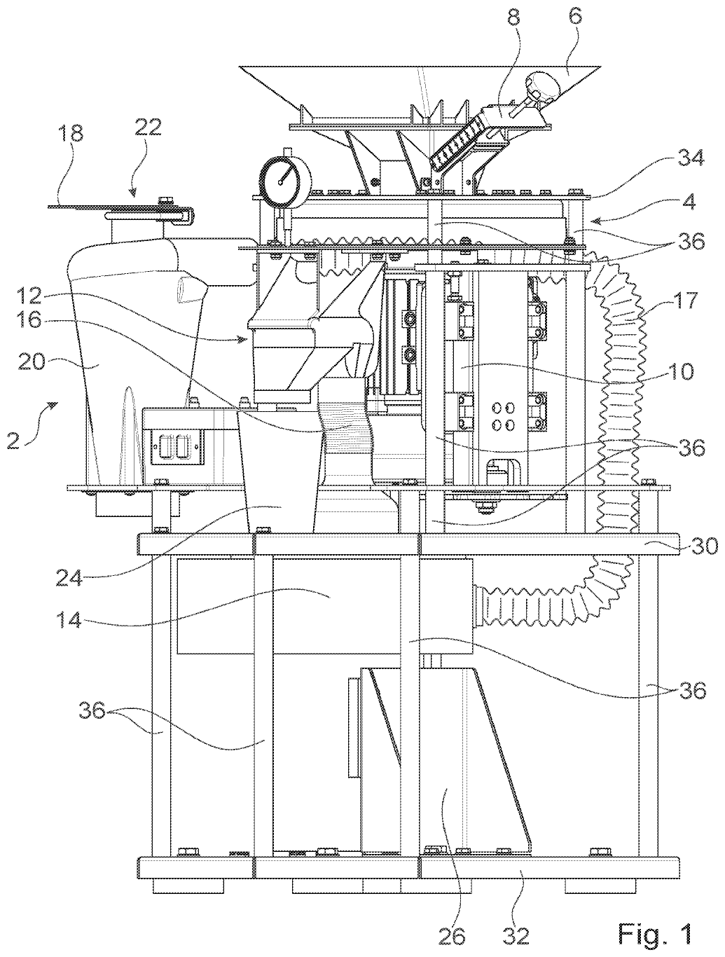

FIG. 1 is a side view of an embodiment of a device according to the invention for producing de-ionized husk grain seeds,

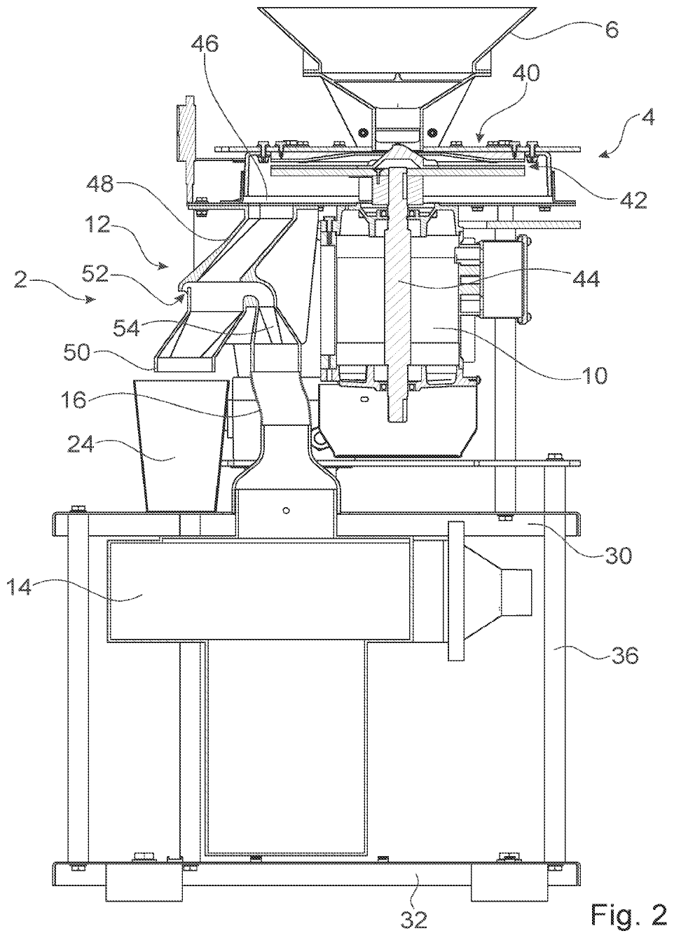

FIG. 2 shows the device from FIG. 1 in a sectional view,

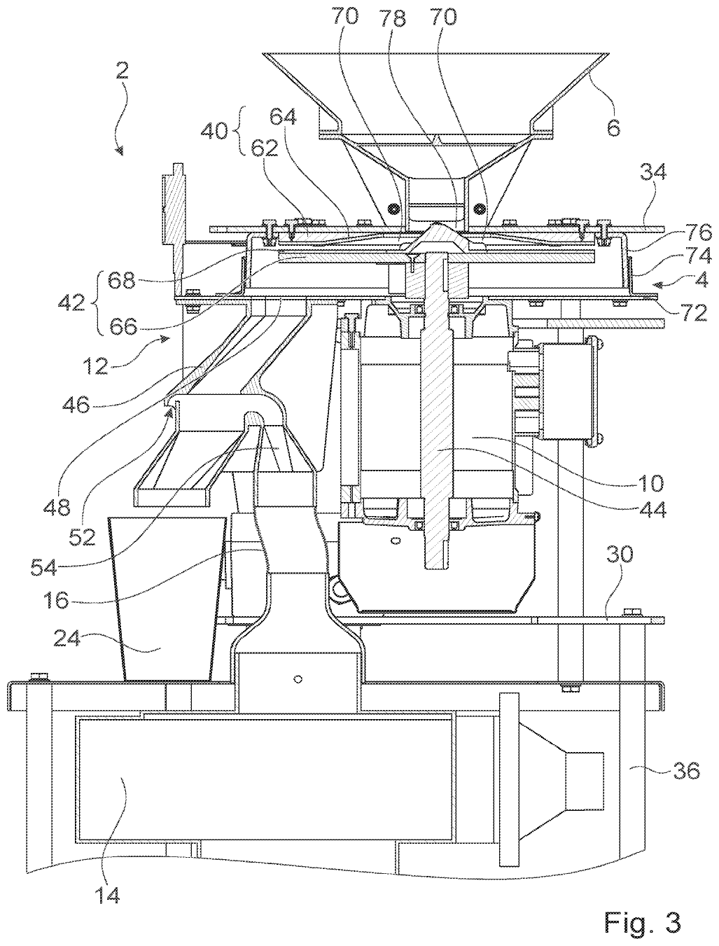

FIG. 3 shows a detail of the device according to the invention from FIG. 2 in the sectional view;

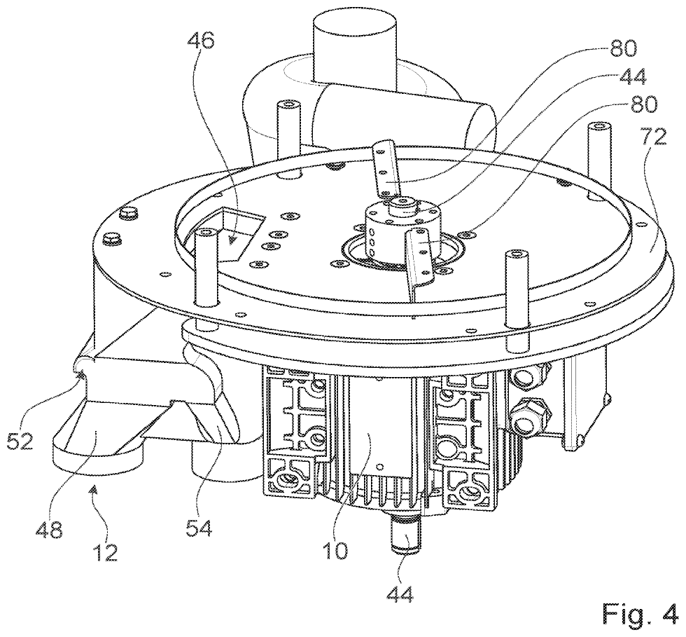

FIG. 4 shows a further detail of the device according to the invention in a side view with partially removed components; and

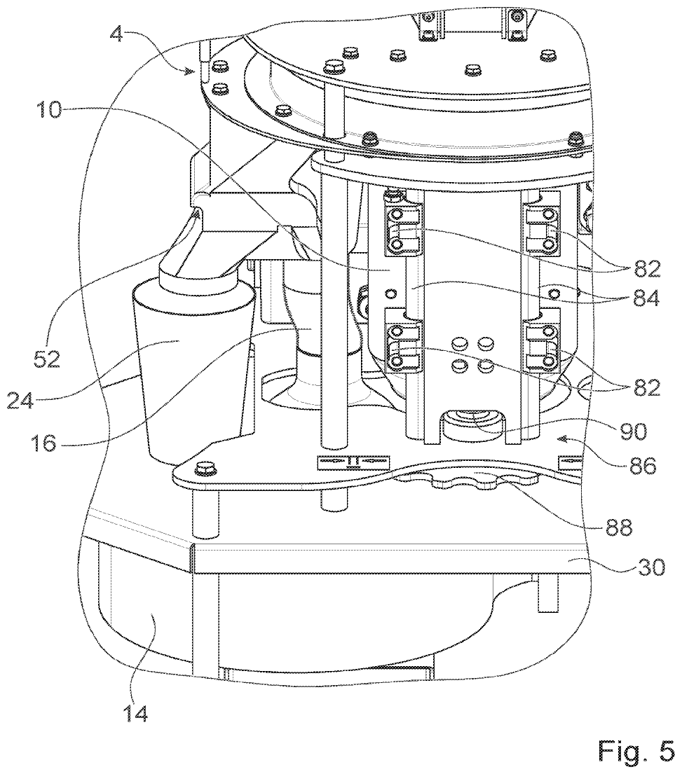

FIG. 5 shows a further detail of the device according to the invention in a side view.

In the figures, identical or identically acting components are provided with the same reference numerals.

FIG. 1 shows, in a side view, a device 2 for the dehusking of husk cereals, which can be used as laboratory or small-quantity peeler of husk grains and for the production of dehusked husk grain seeds. For this purpose, the device 2 has a peeling device 4. The peeling device 4 can be supplied via a funnel 6 to husk grain. The feed of husk cereals via the funnel 6 can be adjusted by means of a slide 8, which can have a cross-section in the interior of the funnel 6 in such a way that the quantity reached in the peeling device 4 can be adjusted. Below the peeling device 4, an electric motor 10 connected thereto, the function of which will be explained below, is arranged.

Furthermore, the device 2 has an aspiration 12 which separates grain and husk from the peeling device 4, as will be explained below. For this purpose, the device has a suction fan 14, which is connected to the aspiration 12 by means of a hose 16 and, on the other hand, forms a connection to a collecting container 20 over a further hose line 17. The husk separated from the grain is discharged via this path. The grain arrives in the collecting vessel 24. This process, also referred to as air separation, can be regulated both via a speed control of a further electric motor 26 of the suction fan 14 and via a further slide 18 at an outlet 22 of the collecting container 20. The further slide 18 thus acts like an exhaust air throttle which limits the air flow through this path. In this case, husk at the lower end of the collecting container 20 can be filled, for example, into a transport bag, while the air leaves this path via the outlet 22 of the collecting container 20.

In order to provide mechanical stability to the device 2, a plurality of main bodies 30, 32, 34 connected via struts are provided, wherein the central main body 30 is arranged above the suction fan 14, the lower main body 32 carries the further electric motor 26 of the suction fan, and the upper main body 34 provides a termination of the peeling device 4. The main bodies are connected to one another via corresponding struts 36.

The peeling device 4 has in its interior a first disk 40 and a second disk 42, wherein the second disk is driven by the electric motor 10 via a vertically arranged axis of rotation 44.

FIG. 2 shows a sectional view of the device 2, wherein the vertical sectional plane is arranged centrally through the axis of rotation 44. It can be seen that the aspiration 12 merges via an outlet opening 46 into a downpipe 48, the lower end 50 of which is arranged above the collecting vessel 24. A supply air opening 52, which is connected to the hose line 16 and thus to the suction fan 14 via a suction channel 54, has been provided on the downpipe 48. In the region of the supply air opening 52, an air flow is generated via the suction fan 14, which air stream is adjusted via the above-described controllability in such a way that husk is separated from the suction fan 14 via the hose line 16 and does not pass into the collecting vessel 24.

A more detailed representation of the peeling device 4 and the aspiration 12 is given below in the enlarged representation of FIG. 3. It can be seen that both the first disk 40 and the second disk 42 are constructed in two parts, wherein the first disk 40 is composed of a first carrier plate 62 and a first cover 64 made of a temperature-stable and elastic material while the second disk 42 consists of a second carrier plate 66 and a second coating 68 of a temperature-stable and elastic material is formed. The first disk 42 is connected to the upper base body 34 so that the heat generated by the base body 34 can be absorbed.

Toward the axis of rotation 44, the first disk 42 is formed with a decreasing transverse section, wherein the first disk 42 is in full surface contact with the upper base body 34, so that wedge-shaped depressions 70 are formed which widen towards the axis of rotation 44. As a result of the configuration of these wedge-shaped regions 70, the supply of husk grains in the region of a filling opening 78 close to the axis of rotation 44 can be optimized. The first coating 64 or the second coating 68 is typically bonded to the support plates 62 and 66, respectively, as a plastic material. In this case, food-genuine polyurethane or a silicone material can be used. Besides these materials, ethylene-propylene-diene rubbers or a natural rubber material may also be included. Usually, different material materials are used in the dehusking of husk cereals and in the production of seed. In addition to the elastic property and the temperature stability, a further characteristic variable is the slip inhibition with respect to the husk grain, which should be taken into account in the selection of materials. The slip inhibition can also be modified in a targeted manner via the surface condition, so that, depending on the material, smooth, corrugated surfaces or surfaces provided with micro structuring are also used. As a result of the selection of the material, the husk grain can be put into a rotational movement or swirl, so that during the passage of the peeling device 4 grain and husk completely separate, without only being peeled off locally.

At one point, the outlet opening 46, which, as described above, leads to the downpipe 48 is located on the circumferential side of the two disks 40, 42. The electric motor 10 is directly connected to the second disk 42, wherein the combination of the electric motor 10, the second disk 42, the downpipe 48 and the lower housing area 72 of the peeling device 4 can be displaced jointly in the axial direction of the axis of rotation 44 in order to determine the distance between the first disk 40 and the second disk 42 can be designed to be adjustable, for example in a range between 0.1 mm and 10 mm.

For this reason, the hose line 16 is flexible in order to be able to compensate for the changing distance between the aspirator 12 and the suction fan 14 when the assembly is in use. Lateral housing sections 74 and 76 are formed so as to overlap, so that when the distance between the first disk 40 and the second disk 42 is adjusted, no lateral openings result at the peeling device 4. In the enlarged illustration of FIG. 3, the slot-shaped configuration of the supply air opening 52 can also be clearly seen, as well as the configuration of the aspiration 12 in the interior.

FIG. 4 again shows a part of the device 2, in which a large part of the components of the peeling device 4 and below the aspiration 12 have been removed. In this embodiment, the region below the second disk 42 can be seen, wherein the lower housing region 72 is still present, which is arranged directly above the electric motor 10. It can be seen that, in the region below the second disk 42, two strippers 80 connected thereto are provided, which are fixedly connected to the second disk 42, so that material is guided through the rotational movement of the second disk 42 in the direction of the outlet opening 46 during operation of the device 2.

A further aspect is explained below with reference to FIG. 5. FIG. 5 shows a detailed view of the side of the electric motor 10, where it can be seen in FIG. 5 that the electric motor 10 is movable up or down on rails 84 via a plurality of sliders 82, wherein the movement of the electric motor 10 takes place via a spindle drive 86 which has a flange 88 which causes a threaded rod 90 to rotate so that via a corresponding counter element on the electric motor 10 (not shown in FIG. 5), which is provided with an internal thread and is penetrated by the wound rod 90, a vertical displacement of the electric motor 10 can be achieved. By selecting a corresponding thread shape in the case of play as a fine thread, a very precise adjustment can take place here. A transmission ratio would also be possible.

In a method for dehusking husk grain, in particular as a laboratory or small-quantity peeler of husk cereal grain and for the production of dehusked cereal seeds, a device 2 can be used as described above, which delivers approximately 1 kg of corresponding grain or seed per minute.

The features mentioned above and the features which can be found in the claims and those which can be found in the claims can be advantageously realized both individually and in various combinations. The invention is not limited to the exemplary embodiments described, but can be modified in many ways within the capabilities of a person skilled in the art.

### LIST OF REFERENCE SYMBOLS

2 device
4 peeling device
6 funnel
8 slide
10 Electric motor
12 aspiration
14 Suction blower
16 Hose line
17 further hose line
18 further slide
20 collection container
22 output
24 collection vessel
26 further electric motor
28 further slide
30 middle main body
32 lower main body
34 upper main body
36 struts
40 First disk
42 Second disk
44 Axis of rotation
46 Outlet opening
48 Downpipe
50 End
52 Supply air opening
54 Suction channel
62 First carrier plate
64 First coating
66 Second carrier plate
68 second coating
70 wedge-shaped region
72 Housing region
74 Second housing section
76 First housing section
78 Filling opening
80 Stripper
82 Glider
84 rails
86 Spindle drive
88 Hand wheel
90 Threaded rod

1. A device for the dehusking of husk cereals, in particular as a laboratory or small-quantity peeler of husk cereals and for the production of de-husk cereal seeds, which comprises a peeling device (4) which comprises a first disk (40) and a second disk (42) which is movable relative to the first disk (40) and which can be driven by a vertical axis of rotation (44), wherein the disks (40;42) are formed between their one surface made of a temperature-stable and elastic material (64; 68) to enclose a working space, which can be filled by the second disk (42) opposite side through a filling opening (78) of the first disk (40) in the region of its center point with husk grain, wherein by rotation of the second disk (42) a peeling off of grain and husk of the husk grain takes place by means of a radial movement along the disks (40;42) so that grain and husk of the husk grain leave the downpipe (4) on its outer circumference via an outlet opening (46) which opens into a collecting vessel (24) via a downpipe (48), wherein the downpipe (48) has a lateral supply air opening (52), which is acted upon by an air flow such that husk leaves the downpipe (58) laterally in front of the collecting vessel (24).

2. The device according to claim 1, wherein the first disk (40) and the second disk (42) each have a support plate (62;66) which are preferably made of aluminum.

3. The device according to claim 1, wherein the temperature-stable and elastic material (64;68) is a plastic material or a natural rubber.

4. The device according to claim 1, wherein the temperature stable and elastic material (64;68) is made with a smooth surface, a corrugation or a microstructure on the surface.

5. The device according to claim 1, in which the temperature stable and elastic material (64;68) is connected to the carrier plate (62;66) in a form-fitting or materially bonded manner.

6. The device according to claim 1, wherein the second disk (42) is coupled to an electric motor (10).

7. The device according to claim 6, wherein the electric motor (10) is additionally coupled to a suction fan (14) for generating the air flow.

8. The device according to claim 1, in which a further electric motor (26) is additionally coupled to a suction fan (14) for generating the air stream.

9. The device according to claim 1, in which the axial spacing of the disks (40;42) can be adjusted in a variable manner.

10. The device according to claim 9, in which the second disk (42) is provided with a spindle drive (86) in order to adjust the distance from the first disk (40), in particular in a range between 0.1 mm and 10 mm.

11. The device according to claim 1, in which the first disk (40) is thermally connected to a main body (30;32;34) of the device (2).

12. The device according to claim 1, wherein the main surface of the first disk (40) tapers in a wedge-shaped manner in the direction opposite to the second disk (42) in the direction opposite to the second disk (42) in the region of the filling opening (78).

13. The device according to claim 1, in which one or more strippers (80) are arranged below the second disk (42), which support the leaving of grain and husk of the husk grain in the direction of the outlet opening (46).

14. A method for the dehusking of husk cereals, in particular as laboratory or small-quantity peeler of husk grains, and for the production of de-husk cereal seeds with the device (2) according to claim 1, which delivers approximately 1 kg of corresponding grain or seed per minute.

15. A dehusked grain of a husk grain produced with the device (2) according to claim 1.
